(19) United States
(12) Patent Application Publication
(10) Pub. No.: US 2026/0091563 A1
(43) Pub. Date: Apr. 2, 2026

(54) VARIABLE GEOMETRY COMPONENT FROM OPF NEEDLED CYLINDER

(71) Applicant: Goodrich Corporation, Charlotte, NC (US)

(72) Inventors: Kyle Rosenbrock, Pueblo, CO (US); Paul T Perea, Pueblo West, CO (US); Kyle Reece Johnston, Pueblo, CO (US)

(73) Assignee: Goodrich Corporation, Charlotte, NC (US)

(21) Appl. No.: 19/303,154

(22) Filed: Aug. 18, 2025

Related U.S. Application Data
(60) Provisional application No. 63/701,250, filed on Sep. 30, 2024.

(51) Int. Cl. B29C 70/22; B29C 51/00; B29C 51/08; B29C 70/30; B29C 70/54; B29K 105/08; B29K 233/20; B29K 307/04

(52) U.S. Cl. CPC B29C 70/222; B29C 51/004; B29C 51/082; B29C 70/30; B29C 70/543; B29K 2105/08; B29K 2233/20; B29K 2307/04

(57) ABSTRACT

A shape forming tool for pre-carbonization shaping of a fibrous preform is provided, comprising a rounded preform and an inner die to fit within the preform. The rounded preform may be a cylindrical, conical, or frustoconical shape. The inner die may be of a non-uniform diameter and/or have complex features. The preform may shrink to conform to the inner die.

### CROSS REFERENCE TO RELATED APPLICATIONS

This application claims priority to and the benefit of U.S. Provisional Patent Application No. 63/701,250, entitled “VARIABLE GEOMETRY COMPONENT FROM OPF NEEDLED CYLINDER,” filed on Sep. 30, 2024, which is hereby incorporated by reference in its entirety for all purposes.

### FIELD

The present disclosure relates to carbon/carbon composites, and more specifically, to systems and methods for manufacturing carbon/carbon (C/C) composites.

### BACKGROUND

Composite bodies are utilized in various industries, including the aerospace industry. C/C composites are often produced as 2D structures, for example utilizing planar oxidized polyacrylonitrile (PAN) fiber-based preforms followed by carbonization and chemical vapor infiltration (CVI) densification. The present application provides for utilizing rounded oxidized polyacrylonitrile (PAN) fiber-based preforms to form hollow structures.

### SUMMARY

According to various embodiments, shape forming tool systems and methods are disclosed. In various embodiments, the present disclosure provides for a method for manufacturing a C/C part. In various embodiments, the method for manufacturing a C/C part may comprise arranging a fibrous preform about a mandrel, the fibrous preform having layers circumferentially disposed relative to the mandrel. In various embodiments, the method for manufacturing a C/C part may comprise needling the fibrous preform in the radial direction with respect to the mandrel. In various embodiments, the method for manufacturing a C/C part may comprise removing the fibrous preform from the mandrel. In various embodiments, the method for manufacturing a C/C part may comprise arranging the fibrous preform circumferentially around an inner die. In various embodiments, the method for manufacturing a C/C part may comprise heating the fibrous preform to conform to the inner die.

In various embodiments, the fibrous preform may be an oxidized polyacrylonitrile (PAN) fiber-based preform. In various embodiments, the inner die may be a graphite die.

In various embodiments, the method for manufacturing a C/C part may comprise rotating the fibrous preform about the mandrel concurrently with the needling of the preform such that the needling results in the fibrous preform being at least one of a cylindrical, conical, or frustoconical shape.

In various embodiments, the method for manufacturing a C/C part may comprise heating the fibrous preform while the preform is arranged around the inner die. In various embodiments, the method for manufacturing a C/C part may comprise cooling the fibrous preform. In various embodiments, the method for manufacturing a C/C part may comprise removing the fibrous preform from the inner die.

In various embodiments, heating the fibrous preform may comprise carbonizing the fibrous preform into a shaped body having pure carbon fibers.

In various embodiments, the shaped body may have a non-uniform diameter.

In various embodiments, the shaped body may comprise a first cross-section having a first outer diameter and a second cross-section having a second outer diameter. In various embodiments, the second cross-section may be axially displaced along the shaped body from the first cross-section. In various embodiments, the first outer diameter may be larger than the second outer diameter.

In various embodiments, the inner die may comprise a groove to receive an O-ring.

In various embodiments, the inner die may comprise a flat feature, the flat feature being parallel to a longitudinal axis of the inner die.

In various embodiments, the present disclosure provides for a shape forming tool system. In various embodiments, the shape forming tool system may comprise an oxidized polyacrylonitrile (PAN) fiber-based preform having at least one of a cylindrical, conical, or frustoconical shape. In various embodiments, the PAN fiber-based preform may comprise z-fibers oriented in a radial direction of the preform. In various embodiments, the shape forming tool system may comprise an inner die. In various embodiments, the inner die may be a graphite die configured to be arranged within the PAN fiber-based preform.

In various embodiments, the inner die may have a non-uniform diameter.

In various embodiments, the inner die may comprise a first cross-section having a first outer diameter and a second cross-section having a second outer diameter. In various embodiments, the second cross-section may be axially displaced along the inner die from the first cross-section. In various embodiments, the first outer diameter may be larger than the second outer diameter.

In various embodiments, the inner die of the shape forming tool system may comprise a third cross-section having a third outer diameter. In various embodiments, the third cross-section may be axially displaced along the inner die from the second cross-section such that the second cross-section is located between the first cross-section and the third cross-section. In various embodiments, the third outer diameter may be larger than the second outer diameter.

In various embodiments, the inner die of the shape forming tool system may comprise a flat feature, the flat feature being parallel to a longitudinal axis of the inner die.

In various embodiments, the inner die of the shape forming tool system may comprise at least one groove for receiving an O-ring.

In various embodiments, the present disclosure provides for a shaped body. In various embodiments, the shaped body may be a fibrous network having at least 99% carbon fiber. In various embodiments, the shaped body may comprise a first terminus. In various embodiments, the shaped body may comprise a second terminus. In various embodiments, the shaped body may comprise a first cross-section located at a first section of the shaped body, the first cross-section having a first outer diameter and a first inner diameter. In various embodiments, the shaped body may comprise a second cross-section axially displaced along the shaped body from the first cross-section, the second cross-section having a second outer diameter and a second inner diameter. In various embodiments, the shaped body may comprise a hollow portion extending from the first terminus to the second terminus.

In various embodiments, the first outer diameter may be greater than the second outer diameter. In various embodiments, the first inner diameter may be greater than the second inner diameter.

In various embodiments, the shaped body may comprise a third cross-section located at a first section of the shaped body. In various embodiments, the third cross-section may be axially displaced along the shaped body from the second cross-section such that the second cross-section is located between the first cross-section and the third cross-section. In various embodiments, the third cross-section may have a third outer diameter and a third inner diameter.

In various embodiments, the third outer diameter may be greater than the second outer diameter. In various embodiments, the third inner diameter may be greater than the second inner diameter.

In various embodiments, the shaped body may comprise a flat feature, the flat feature being parallel to a longitudinal axis of the shaped body.

### BRIEF DESCRIPTION OF THE DRAWINGS

FIG. 1 illustrates a cylindrical pre-treated fibrous preform, in accordance with various embodiments;

FIG. 2 illustrates a frustoconical pre-treated fibrous preform, in accordance with various embodiments;

FIG. 3 illustrates an inner die with a non-uniform diameter and/or complex geometry, in accordance with various embodiments;

FIG. 4 illustrates a fibrous preform arranged about an inner die, in accordance with various embodiments;

FIG. 5 illustrates a fibrous preform conformed to contours of the inner die, in accordance with various embodiments;

FIG. 6A illustrates a shaped body removed from the inner die, in accordance with various embodiments;

FIG. 6B illustrates shaped body cross-sections, in accordance with various embodiments;

FIG. 7A illustrates a longitudinal view of a fibrous preform arranged around a mandrel, in accordance with various embodiments;

FIG. 7B illustrates an axial view of view of a fibrous preform arranged around a mandrel, in accordance with various embodiments;

FIG. 8 illustrates a method of forming a C/C part, in accordance with various embodiments.

### DETAILED DESCRIPTION

All ranges and ratio limits disclosed herein may be combined. It is to be understood that unless specifically stated otherwise, references to “a,” “an,” and/or “the” may include one or more than one and that reference to an item in the singular may also include the item in the plural.

The detailed description of exemplary embodiments herein makes reference to the accompanying drawings, which show exemplary embodiments by way of illustration and its best mode, and not of limitation. While these exemplary embodiments are described in sufficient detail to enable those skilled in the art to practice the invention, it should be understood that other embodiments may be realized and that logical, chemical and mechanical changes may be made without departing from the spirit and scope of the invention. For example, the steps recited in any of the method or process descriptions may be executed in any order and are not necessarily limited to the order presented. Moreover, many of the functions or steps may be outsourced to or performed by one or more third parties. Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option. Additionally, any reference to without contact (or similar phrases) may also include reduced contact or minimal contact.

As used herein, “fiber volume ratio” means the ratio of the volume of the fibers of the fibrous preform to the total volume of the fibrous preform. For example, a fiber volume ratio of 25% means the volume of the fibers in the fibrous preform is 25% of the total volume of fibrous preform.

As used herein, the term “fiber density” is used with its common technical meaning with units of g/cm³ or g/cc. The fiber density may refer specifically to that of the individual fibers in the fibrous preform. The density will be measured, unless otherwise noted, by taking the weight divided by the geometric volume of each fiber. The density may refer to an average density of a plurality of fibers included in a fibrous preform.

As used herein, “CVI/CVD” may refer to chemical vapor infiltration and/or chemical vapor deposition. Accordingly, CVI/CVD may refer to chemical vapor infiltration or deposition or both.

As used herein, the terms “tow” and “cable” are used to refer to one or more strands of substantially continuous filaments. Thus, a “tow” or “cable” may refer to a plurality of strands of substantially continuous filaments or a single strand of substantially continuous filament.

As used herein, the unit “K” represents “thousand.” Thus, a 1 K tow means a tow comprising about 1,000 strands of substantially continuous filaments. For example, a “heavy tow” may comprise about 48,000 (48 K) textile fibers in a single tow, whereas a “medium tow” may comprise about 24,000 (24 K) textile fibers within a single tow whereas a “lighter tow” may comprise about 6,000 (6 K) textile fibers within a single tow. Fewer or greater amounts of textile fibers may be used per cable in various embodiments. In various embodiments disclosed herein, starting carbon fiber tows in accordance with various embodiments may comprise tows of from about 0.1 K to about 100 K, and, in various embodiments, heavier tows. In general, there are currently two primary methods of manufacturing carbon/carbon (“C/C”) materials. The first method involves the layup and cure of a carbon fiber, phenolic resin matrix composite, followed by pyrolysis and subsequent phenolic resin infiltration and pyrolysis cycles. Multiple resin infiltration, cure, and pyrolysis cycles are typically used until the part achieves the desired density. The second method involves fabrication of an oxidized polyacrylonitrile fiber (OPF), or carbon fiber preform, followed by carbonization (for OPF preforms) and chemical vapor infiltration (CVI) densification. The present disclosure is not limited to carbon/carbon materials. Wherein the terms carbon/carbon or C/C are used herein, it is to be appreciated that these materials may comprise pure C/C as described and may also comprise Silicon Carbide (SiC) or Zirconium Carbide (ZrC) to form, for example, C/SiC, C/C—SiC, or C/ZrC components.

C/C material is generally formed by utilizing either continuous oxidized polyacrylonitrile (PAN) fibers, referred to as “OPF” fibers or carbonized carbon fibers, referred to herein as carbon fibers. Such fibers are used to fabricate a preform shape using a needle punching process. OPF fibers or carbon fibers are layered in a selected orientation into a preform of a selected geometry. Two or more layers of fibers are layered onto a support and are then needled together simultaneously or in a series of needling steps. This process interconnects the horizontal fibers with a third direction (also called the z-direction). The fibers extending into the third direction are also called z-fibers. This needling process may involve driving a multitude of barbed needles into the fibrous layers to displace a portion of the horizontal fibers into the z-direction. Carbonization/graphitization may be conducted in a vacuum or partial vacuum (e.g., at pressures of 1 millitorr to 15 torr, at pressures of 1-10 millitorr, at pressures of 1-15 torr) or in an inert atmosphere at a temperature in the range from about 1,200° C. to about 2,800° C. (2,192° F. to about 5,072° F.), and in various embodiments in the range from about 1,600° C. to about 2,200° C. (2,912° F. to about 3,992° F.), and in various embodiments in the range from about 1,600° C. to about 2,500° C. (2,912° F. to about 4,532° F.) (wherein the term about in this context only means +/−100° C.) for a period of time in the range of up to about 100 hours, and in various embodiments, in the range up to about 80 hours (wherein the term about in this context only means +/−20 hours). In various embodiments, carbonization/graphitization may be conducted in an inert vacuum or an inert partial vacuum at the above recited temperature ranges and times. The resulting preform generally has the same fibrous structure as the fibrous preform before carbonizing. However, the OPF have been converted to 100% carbon or very near 100%, for example from 95% carbon to 99.9% carbon. The resulting preform may be referred to as having a fibrous network. In various embodiments, the carbonization process imparts high temperature dimensional stability to the final C/C part. In various embodiments, the carbonization process imparts desired thermal properties associated with thermal shock such as high thermal conductivity, high heat capacity, and/or high emissivity.

After the preform has been carbonized, the preform is densified. In general, densification involves filling the voids, or pores, of the fibrous preform with additional carbon material. This may be done using the same furnace used for carbonization or a different furnace. Typically, chemical vapor infiltration and deposition (“CVI/CVD”) techniques are used to densify the porous fibrous preform with a carbon matrix. This commonly involves heating the furnace and the carbonized preforms, and flowing hydrocarbon gases (e.g., at least one of methane, ethane, propane, butane, and/or the like, as described herein) into the furnace and around and through the fibrous preforms. The hydrocarbons may comprise alkanes, for example, straight chain, branched chain and/or cyclic alkanes, having from 1 to about 8 carbon atoms, and in various embodiments from 1 to about 6 carbon atoms, and in various embodiments from 1 to about 3 carbon atoms. Methane, ethane, propane, cyclopentane, or mixtures of two or more thereof may be used. The gas may comprise one or more alkanes of 2 to about 8 carbon atoms, and in various embodiments from 2 to about 6 carbon atoms. Mixtures of one or more alkanes of 1 to about 8 carbon atoms with one or more alkenes of 2 to about 8 carbon atoms may be used. In various embodiments, fibrous preform may undergo an infiltration with a resin or pitch material to form a matrix therein.

As a result, carbon from the hydrocarbon gases separates from the gases and is deposited on and within the fibrous preforms. When the densification step is completed, the resulting C/C part has a carbon fiber structure with a carbon matrix infiltrating the fiber structure, thereby deriving the name “carbon/carbon.” It is again noted that the present disclosure is not limited to carbon/carbon materials. Wherein the terms carbon/carbon or C/C are used herein, it is to be appreciated that these materials may comprise pure C/C as described and may also comprise Silicon Carbide (SiC) or Zirconium Carbide (ZrC) to form, for example, C/SiC, C/C—SiC, or C/ZrC components.

A third method may involve a combination of the two aforementioned processes including layup and cure of a carbon fiber, phenolic resin matrix composite, followed by pyrolysis, and CVI densification.

C/C parts of the present disclosure are formed using OPF fabrics that are shape-formed prior to carbonization. C/C parts of the present disclosure may be formed using multi-axial, non-crimp, stitch-bonded, OPF fabrics that are shape-formed prior to carbonization. C/C parts of the present disclosure may be particularly useful for high temperature aerospace applications, such as for re-entry vehicle applications or other high temperature applications such as where a hot gas impinges on the vehicle after being rapidly compressed and heated. C/C parts of the present disclosure may be especially useful in these applications because of the superior high temperature characteristics of C/C material. In particular, the carbon/carbon material used in C/C parts is a good conductor of heat and is able to dissipate heat generated during high temperature conditions. Carbon/carbon material is also highly resistant to heat damage, and thus, may be capable of sustaining forces during severe conditions without mechanical failure. Application of OPF-based carbon-carbon composites has been generally limited to simple flat structures including C/C aircraft brake disks. C/C components including leading edges, structural members and other contour-shape carbon composites are often produced as 2D structures (i.e., flat, planar components); however, these materials tend to maintain low interlaminar properties. A shape formed 3D C/C part offers opportunity for similar in-plane C/C properties with higher interlaminar properties than 2D C/C.

Disclosed herein are systems and methods for forming a preform into a shaped body. The systems and methods relate to complex geometry carbon preforms for C/C composites with rounded and/or hollow features. To properly form a rounded or hollow preform, it is desirable to first form the OPF preform into a rounded and/or hollow shape and to shrink the OPF preform to conform to an inner die.

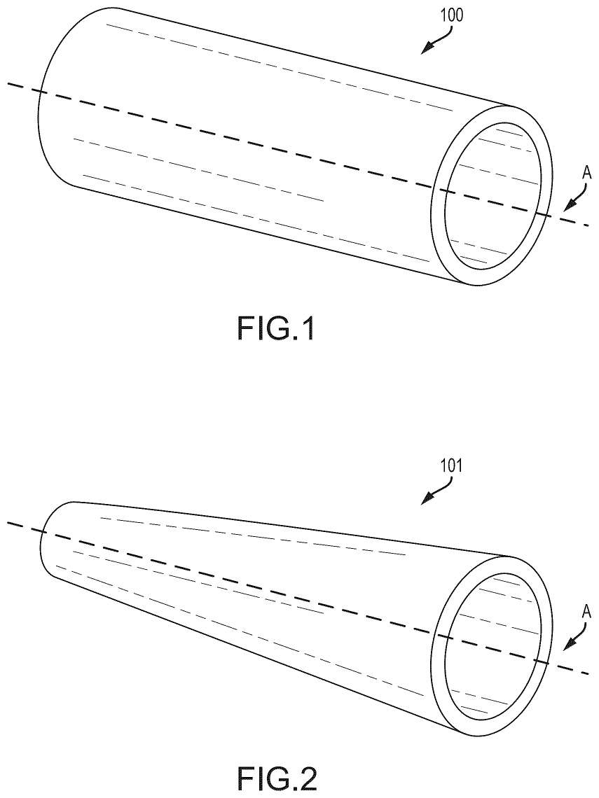

With reference to FIG. 1, a fibrous preform 100 is illustrated. The fibrous preform 100 may be of a round shape. The fibrous preform 100 may be of a hollow shape. In various embodiments, the fibrous preform may be, as shown in FIG. 1, of a cylindrical shape and comprise a cylindrical hollow portion. In various embodiments, the fibrous preform may have a uniform inner and outer diameter. In various embodiments, the fibrous preform may have a uniform thickness.

With reference to FIG. 2, a fibrous preform 101 is illustrated. The fibrous preform 101 may be of a frustoconical or conical shape. The fibrous preform 101 may be of a hollow shape. In various embodiments, the fibrous preform may be, as shown in FIG. 2, of a frustoconical shape and comprise a hollow portion. In various embodiments, the fibrous preform may have a uniform thickness.

Fibrous preform 100 or 101 may have a longitudinal axis, A.

Fibrous preforms 100 and 101 may comprise polyacrylonitrile (PAN) or OPF fibers extending in three directions and leaving a plurality of pores or open spaces and may be prepared for shape-forming, compression, and carbonization. In various embodiments, fibrous preforms 100 and 101 are formed by stacking layers of PAN or OPF fibers and superimposing the layers.

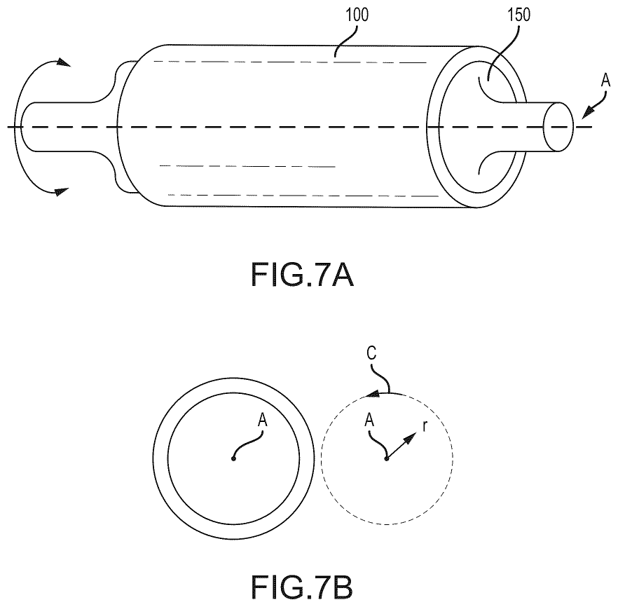

With reference to FIGS. 7A and 7B, fibrous preforms 100 and 101 may be formed by arranging sheets of fabric circumferentially around a mandrel 150. In various embodiments, the fibrous preform 100 or 101 can be made of polyacrylonitrile (PAN) or OPF fibers extending in three directions and leaving a plurality of pores or open spaces and may be prepared for shape-forming, compression, and carbonization. The layers may be needled perpendicularly to each other (i.e., along a radial direction, r, also referred to herein as the z-direction) with barbed, textile needles or barbless, structuring needles. In various embodiments, the layers are needled at an angle of between 0° and 89° (e.g., 0°, 30°, 45°, 60°, and/or) 89° with respect to the radial direction in order to be needled to each other. The needling process generates a series of z-fibers through fibrous preform 100 or 101 that extend perpendicularly to the fibrous layers and in the radial direction, r. The z-fibers are generated through the action of the needles pushing fibers from within the layer (circumferentially layered) and reorienting them in the radial direction, r, (through-thickness). Needling of the fibrous preform may be done as one or more layers are added to the stack or may be done after the entire stack of layers is formed. The needles may also penetrate through only a portion of fibrous preform 100 or 101, or may penetrate through the entire fibrous preform 100 or 101. In addition, resins are added, in various embodiments, to fibrous preform 100 or 101 by either injecting the resin into the preform following construction or coating the fibers or layers prior to forming the fibrous preform 100 or 101. The needling process may take into account needling parameters optimized to maintain fiber orientation, minimize in-plane fiber damage, and maintain target interlaminar properties. After needling the fibrous preform 100 or 101, the non-woven fibrous preform 100 or 101 may be formed to shape in a single-step shape-forming process (i.e., using the shape forming tool system of the present disclosure). It should be understood, moreover, that fibrous preforms 100 or 101 not subject to needling prior to pre-carbonization forming are also within the scope of the present disclosure.

The carbonization process may be employed to convert the fibers of the fibrous preform 100 or 101 into pure carbon fibers, as used herein only “pure carbon fibers” means carbon fibers comprised of at least 99% carbon. The carbonization process is distinguished from the densification process described below in that the densification process involves infiltrating the pores of the fibrous preform 100 or 101 and depositing a carbon matrix within and around the carbon fibers of the fibrous preform 100 or 101, and the carbonization process refers to the process of converting the fibers of the fibrous preform 100 or 101 into pure carbon fibers.

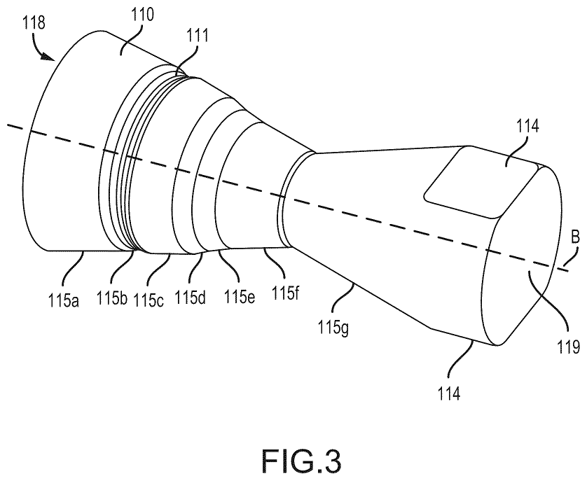

With respect to FIG. 3, an inner die 110 is illustrated. Inner die 110 may be a carbonization tool. Inner die 110 may be a graphite die. Inner die 110 may be of any rigid high temperature material. The inner die 110 may have a non-uniform outer diameter. The inner die 110 may have complex geometry. For example, in various embodiments, the inner die 110 may have a circumferential groove 111. In various embodiments, groove 111 may be for receiving a seal, such as an O-ring. For example, in various embodiments, the inner die 110 may have at least one flat feature 114. Inner die 110 may have numerous flat features 114. For example, inner die 110 may have 2 or more, 4 or more, or 10 or more flat features 114. For example, in various embodiments, inner die 110 may have various sections 115 of differing diameters and/or of differing slopes.

Inner die 110 may have a first end 118 and a second end 119. From first end 118 to second end 119, inner die 110 may have any number (n) of sections 115. For example, as depicted in FIG. 3, inner die 110 may have sections 115a-115g. However, inner die 110 may have fewer or more sections. For example, inner die 110 may have a single section 115a, two sections 115a-b, five sections 115a-e, ten sections 115a-j, or more 115n. Each section 115 may have a constant or varying diameter. For example, as depicted in FIG. 3, section 115c has a first decreasing slope, the slope decreasing from the first end 118 to the second end 119 with respect to the longitudinal axis, B, of the inner die 110. For example, as depicted in FIG. 3, section 115d has a second decreasing slope, the slope decreasing from the first end 118 to the second end 119 with respect to the longitudinal axis, B, of the inner die 110. The slope of 115d is greater than the slope of 115c. For example, as depicted in FIG. 3, section 115f has a constant slope with respect to the longitudinal axis, B, of the inner die 110. For example, as depicted in FIG. 3, section 115g has an increasing slope, the slope increasing from the first end 118 to the second end 119 with respect to the longitudinal axis, B, of the inner die.

In various embodiments, sections 115 may be of equal or varying lengths. For example, as depicted in FIG. 3, section 115d has a shorter length than section 115g. However, section 115g may have a shorter length than section 115d.

While inner die 110 is depicted in FIG. 3 with a groove 111 and numerous flat features 114, inner die 110 may have only a groove 111, only flat feature 114, or neither a groove 111 nor flat feature 114. While inner die 110 is depicted in FIG. 3 with numerous sections 115 of varying diameters and slopes, the sections 115 may be in any order. For example, inner die 110 may have a single section 115 of decreasing diameter or a single section 115 of increasing diameter. For example, inner die 110 may have a first section 115a increasing in diameter, a second section 115b of constant diameter, and a third section 115c of decreasing diameter. Inner die 110 may have any combination of sections 115 with increasing, decreasing, or constant diameter.

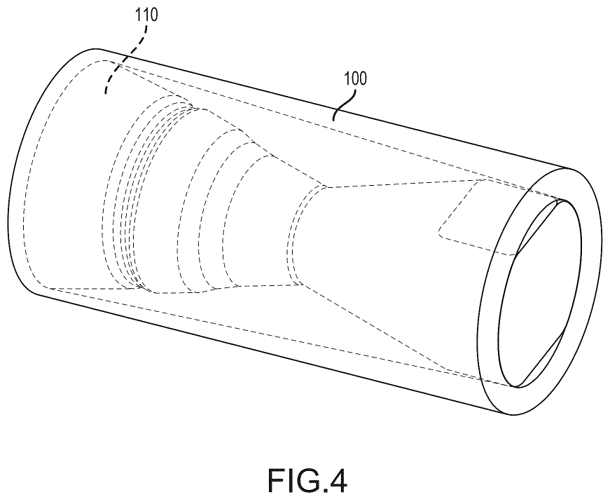

With respect to FIG. 4, fibrous preform 100 or 101 is arranged about inner die 110. The inner diameter of fibrous preform 100 or 101 at all points may be greater than the outer diameter of inner die 110. For example, if the fibrous preform 100 is, as depicted in FIG. 4, cylindrical, the greatest diameter of the inner die 110 may be less than the inner diameter of the cylindrical fibrous preform 100. For example, if the fibrous preform 101 is frustoconical or conical shaped, the outer diameter of the inner die 110 at any point along the longitudinal axis, B, may be less than the inner diameter of the fibrous preform 101 at a corresponding point of the fibrous preform 101 along the longitudinal axis, A.

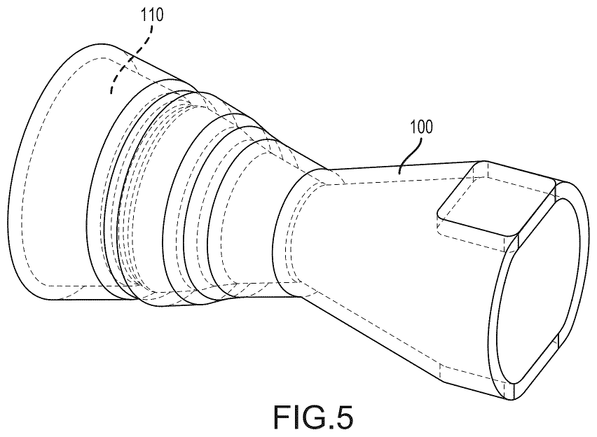

With respect to FIG. 5, the fibrous preform 100 or 101 may be shaped or shrunk to conform to the inner die 110 while positioned around inner die 110. In response to conforming to the inner die 110, fibrous preform 100 or 101 may have an internal geometry complementary to the outer geometry of the inner die 110. In response to conforming to the inner die 110, fibrous preform 100 or 101 may have an external geometry complementary to the outer geometry of the inner die 110.

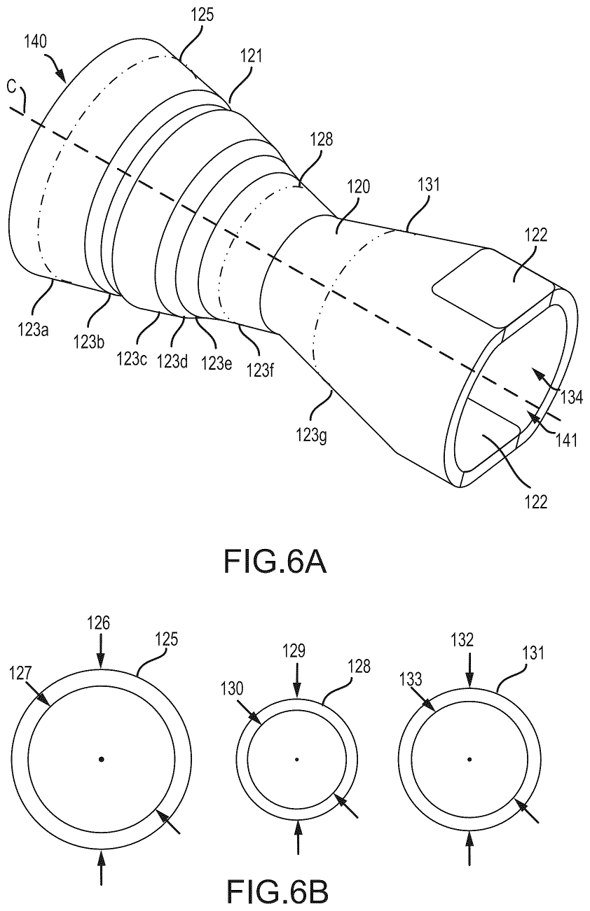

With respect to FIGS. 6A and 6B, in response to conforming to the inner die 110, fibrous preform 100 or 101 may be formed into a shaped body 120. Shaped body may have a first terminus 140 and a second terminus 141. Once removed from the inner die 110, the shaped body 120 may comprise the features of inner die 110, such as: a groove 121, flat surfaces, 122, and various sections 123n (similar to sections 115n) of varying length and diameter.

FIGS. 6A and 6B depicts as an example, a shaped body 120 with a groove 121, flat surfaces 122, and sections 123a-g. However, shaped body 120 may comprise only a groove 121, only a flat surface 124, both, or neither. Similarly, shaped body 120 may comprise any number of sections 123 and sections 123 may have varying lengths, diameters, and slopes in any order along longitudinal axis, C.

In various embodiments, shaped body 120 may have a first cross-section 125 having a first outer diameter 126 and a first inner diameter 127. In various embodiments, shaped body 120 may have a second cross-section 128 having a second outer diameter 129 and a second inner diameter 130. Second cross-section 128 may be axially displaced from first cross-section 125. In various embodiments, shaped body 120 may have a third cross-section 131 having a third outer diameter 132 and a third inner diameter 133. Third cross-section 131 may be axially displaced from first cross-section 125 and second cross-section 128. Second cross-section 128 may be between first cross-section 125 and third cross-section 131.

In various embodiments, shaped body 120 may have a hollow portion 134 extending from the first terminus 140 to the second terminus 141.

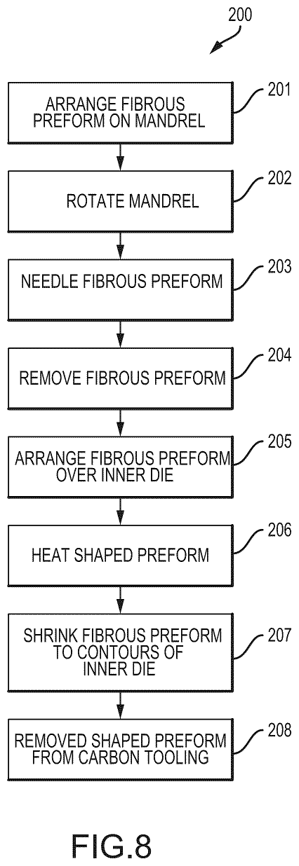

With respect to FIG. 8, a method 200 for forming manufacturing a C/C part is provided.

In step 201, fibrous preform 100 or 101 may be arranged on a mandrel 150. Fibrous preform 100 or 101 may be arranged around the mandrel 150 such that fibrous preform 100 or 101 is coaxial with mandrel 150.

In step 202, mandrel 150 may be rotated. Fibrous preform 100 or 101 may rotate about longitudinal axis, B, of the inner die 110 in response to the rotation of the mandrel 150.

In step 203, as described above, fibrous preform 100 or 101 may be needled, as described above. Step 203 may comprise arranging multiple layers around the mandrel 150 to form fibrous preform 100 or 101. Step 203 may comprise needling fibrous preform 100 or 101 such that the fibrous preform 100 or 101 is formed into cylindrical, conical, or frustoconical shape. Step 203 may be performed before, after, or concurrently with step 202. Step 203 may be performed without step 202.

In step 204, fibrous preform 100 or 101 may be removed from the mandrel 150.

In step 205, fibrous preform 100 or 101 may be arranged around an inner die 110. Fibrous preform 100 or 101 may be arranged around inner die 110 such that fibrous preform 100 or 101 is coaxial with inner die 110. Inner die 110 may be as described above.

In step 206, fibrous preform 100 or 101 may undergo a carbonization process during which fibrous preform 100 or 101 may be heated. Carbonization process 206 may be conducted in a furnace. Carbonization may be conducted in a vacuum or partial vacuum (e.g., at pressures of 1-15 torr) or in an inert atmosphere at a temperature in the range from about 1200° C. to about 2600° C. (2,192° F. to about 4,712° F.), and in various embodiments in the range from about 1600° C. to about 2200° C. (2,912° F. to about 3,992° F.) (wherein the term about in this context means+/−100° C.) for a period of time in the range of up to 100 hours, or of up to 80 hours (wherein the term about in this context means+/−20 hours). In various embodiments, carbonization/graphitization may be conducted in an inert vacuum or an inert partial vacuum at the above recited temperature ranges and times. In various embodiments, the carbonization process imparts high temperature dimensional stability to the final C/C part. In various embodiments, the carbonization process imparts desired thermal properties associated with thermal shock such as high thermal conductivity, high heat capacity, and/or high emissivity.

After carbonization, the carbonized fibrous preform 100 or 101 may be densified using chemical vapor infiltration (CVI), as described in further detail below. In various embodiments, the carbonized fibrous preform 100 or 101 is removed from inner die 110 prior to densification. In various embodiments, the carbonized fibrous preform 100 or 101 is placed in a perforated graphite fixture during one or more densification runs. The carbonized fibrous preform 100 or 101 may be densified with pyrolytic carbon by CVI using optimized process conditions to maintain shape and support efficient carbon densification. In general, densification involves filling the voids, or pores, of the fibrous preform with additional carbon material. This may be done using the same furnace used for carbonization or a different furnace.

In step 207, the fibrous preform 100 or 101 is condensed (e.g. shrunk) to conform to the contours of the inner die 110. Through shrinking and conforming to the inner die 110, the fibrous preform 100 or 101 is formed into shaped body 120. Shaped body may have a longitudinal axis, C.

In step 208, shaped body 120 is removed from the inner die 110. Inner die 110 may be removed by pressing inner die 110 through shaped body 120. In various embodiments, step 208 comprises cooling the shaped body 120 prior to removal. In various embodiments, removal of the shaped body 120 may occur by translating the shaped body 120 with respect to the inner die 110 such that the shaped body 120 is decoupled from the inner die 110. In this manner, the shaped body 120 would retain its shape after decoupling. In various embodiments, removal of the shaped body 120 may occur by deconstructing at least two components of the inner die 110 in situ such that the inner die 110 components can be individually removed from the shaped body 120 without disrupting the shape or structure of the shaped body 120. The inner die 110 may be configured for single use such that the inner die 110 is destroyed during removal. The inner die 110 may be configured for repeat use such that inner die 110 is not destroyed during removal.

Systems and methods are provided. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the invention. The scope of the invention is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Furthermore, no element, component, or method step in the present disclosure is intended to be dedicated to the public regardless of whether the element, component, or method step is explicitly recited in the claims. No claim element herein is intended to invoke 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. A method for manufacturing a C/C part, the method comprising:
arranging a fibrous preform about a mandrel, the fibrous preform having layers circumferentially disposed relative to the mandrel;
needling the fibrous preform in the radial direction with respect to the mandrel;
removing the fibrous preform from the mandrel;
arranging the fibrous preform circumferentially around an inner die; and
heating the fibrous preform to conform to the inner die.

2. The method of claim 1, wherein the arranging the fibrous preform comprises arranging an oxidized polyacrylonitrile (PAN) fiber-based preform about the mandrel and wherein the arranging the fibrous perform circumferentially around the inner die comprises arranging the fibrous perform circumferentially around a graphite inner die.

3. The method of claim 1, further comprising:
rotating the fibrous preform about the mandrel concurrently with the needling of the preform such that the needling results in the fibrous preform being at least one of a cylindrical, conical, or frustoconical shape.

4. The method of claim 1, further comprising:
heating the fibrous preform while the preform is arranged around the inner die;
cooling the fibrous preform; and
removing the fibrous preform from the inner die.

5. The method of claim 1, wherein the heating the fibrous preform further comprises carbonizing the fibrous preform into a shaped body having pure carbon fibers.

6. The method of claim 1, wherein the heating the fibrous preform further comprises carbonizing the fibrous preform into a shaped body having a non-uniform diameter.

7. The method of claim 1, wherein the heating the fibrous preform further comprises carbonizing the fibrous preform into a shaped body defined by a first cross-section having a first outer diameter and a second cross-section having a second outer diameter, the second cross-section being axially displaced along the shaped body from the first cross-section, and the first outer diameter being larger than the second outer diameter.

8. The method of claim 1, wherein the heating the fibrous preform to conform to the inner die comprises heating the fibrous preform to conform to a groove of the inner die, the groove confirmed to receive an O-ring.

9. The method of claim 1, wherein the heating the fibrous preform to conform to the inner die comprises heating the fibrous preform to conform to a flat feature of the inner die, the flat feature being parallel to a longitudinal axis of the inner die.

10. A shape forming tool system, comprising:
an oxidized polyacrylonitrile (PAN) fiber-based preform having at least one of a cylindrical, conical, or frustoconical shape, wherein the PAN fiber-based preform comprises z-fibers oriented in a radial direction of the preform; and
an inner die, the inner die being a graphite die configured to be arranged within the PAN fiber-based preform.

11. The shape forming tool system of claim 10, wherein the inner die has a non-uniform diameter.

12. The shape forming tool system of claim 10, wherein the inner die comprises a first cross-section having a first outer diameter and a second cross-section having a second outer diameter, the second cross-section being axially displaced along the inner die from the first cross-section, and the first outer diameter being larger than the second outer diameter.

13. The shape forming tool system of claim 12, wherein the inner die comprises:
a third cross-section having a third outer diameter, the third cross-section being axially displaced along the inner die from the second cross-section such that the second cross-section is located between the first cross-section and the third cross-section, and the third outer diameter being larger than the second outer diameter.

14. The shape forming tool system of claim 10, wherein the inner die comprises a flat feature, the flat feature being parallel to a longitudinal axis of the inner die.

15. The shape forming tool system of claim 10, wherein the inner die comprises at least one groove for receiving an O-ring.

16. A shaped body, comprising:
a fibrous network having at least 99% carbon fiber;
a first terminus;
a second terminus;
a first cross-section located at a first section of the shaped body, the first cross-section having a first outer diameter and a first inner diameter;
a second cross-section axially displaced along the shaped body from the first cross-section, the second cross-section having a second outer diameter and a second inner diameter; and
a hollow portion extending from the first terminus to the second terminus.

17. The shaped body of claim 16, wherein the first outer diameter is greater than the second outer diameter, and wherein the first inner diameter is greater than the second inner diameter.

18. The shaped body of claim 16, further comprising:
a third cross-section located at a first section of the shaped body, the third cross-section being axially displaced along the shaped body from the second cross-section such that the second cross-section is located between the first cross-section and the third cross-section, and the third cross-section having a third outer diameter and a third inner diameter.

19. The shaped body of claim 18, wherein the third outer diameter is greater than the second outer diameter, and wherein the third inner diameter is greater than the second inner diameter.

20. The shaped body of claim 16, further comprising a frustoconical shape defining a transition section between the first section and the second section.
